(19) United States
(12) Patent Application Publication
(10) Pub. No.: US 2015/0124808 A1
(43) Pub. Date: May 7, 2015

(54) Network System and Network Relay Device

(71) Applicant: Hitachi Metals, Ltd., Tokyo (JP)

(72) Inventor: Tomoyoshi TATSUMI, Tsuchiura (JP)

(21) Appl. No.: 14/455,178

(22) Filed: Aug. 8, 2014

(30) Foreign Application Priority Data
Nov. 6, 2013 (JP) 2013-230052

(51) Int. Cl. H04L 12/18; H04L 12/947

(52) U.S. Cl. CPC H04L 12/18; H04L 49/25
USPC 370/390

(57) ABSTRACT

A network system includes a plurality of fabric switches and a plurality of port switches connected to the plurality of fabric switches through a plurality of links. A link aggregation group is set to the plurality of links connected to the plurality of fabric switches, and when the port switch receives a multicast management frame, it transfers the frame to each of the plurality of fabric switches. The fabric switch has a table in which information of a port which has received a frame and a source MAC address of a received frame are registered, and when the fabric switch receives the multicast management frame, it registers information of a port which has received the frame and a source MAC address of the frame in the table.

### CROSS-REFERENCE TO RELATED APPLICATION

The present application claims priority from Japanese Patent Application No. 2013-230052 filed on Nov. 6, 2013, the content of which is hereby incorporated by reference into this application.

### TECHNICAL FIELD OF THE INVENTION

The present invention relates to a network system and a network relay device, for example, a network system and a network relay device effectively applied to transmission and reception of a frame between virtual machines (VM) in the virtual extensible local area network (VXLAN).

### BACKGROUND OF THE INVENTION

As a network technology, VXLAN adaptable to the increase of tenants and applications has been known.

Also, as described in Japanese Patent Application Laid-Open Publication No. 2012-249050 (Patent Document 1), a network system with a two-stage configuration made up of a lower layer and an upper layer has been known.

### SUMMARY OF THE INVENTION

In the network system made up of a lower layer and an upper layer, the lower layer is composed of a plurality of lower switches to which terminal devices are connected. Also, the upper layer is composed of a plurality of upper switches connected to each of the plurality of lower switches. In this case, transmission and reception of a frame between terminal devices connected to different lower switches are performed through the upper switch.

Patent Document 1 describes that a link aggregation group is set to a plurality of ports connected to different upper switches in a lower switch. In this case, when the lower switch transmits a received frame to an upper switch, the lower switch transmits the frame so as to be distributed to a plurality of ports belonging to the link aggregation group. In this manner, the transmission and reception of the frame between the terminal devices connected to different lower switches are performed in a distributed manner among the plurality of upper switches, and the wider bandwidth can be achieved.

Meanwhile, in VXLAN, a broadcast frame or a multicast frame from a VM is transmitted by using an IP multicast. For the management of join and leave to and from the multicast group in each VXLAN segment, IGMP (Internet Group Management Protocol) is used. As IGMP frames, there are three kinds of message-type frames. More specifically, there are frames of a membership query, a membership report and a leave group. Also, as a protocol for managing the multicast group, there is MLD (Multicast Listener Discovery). In the present specification, a frame of the protocol which manages the multicast group such as IGMP frame and MLD frame is referred to as a multicast management frame.

When VXLAN is applied to the network system disclosed in Patent Document 1, the multicast management frame used in VXLAN is transmitted so as to be distributed to a plurality of ports belonging to a link aggregation group. In this case, there exists an upper switch to which the multicast management frame is not transferred. In the upper switch to which the multicast management frame is not transferred, a source MAC (Media Access Control) address contained in the frame cannot be registered. Due to this, flooding occurs, and it causes the problem of the shortage in the bandwidth of the network system.

Patent Document 1 does not take account of the transmission of the multicast management frame.

An object of the present invention is to provide a network system and a network relay device capable of suppressing the occurrence of the flooding.

The above and other objects and novel characteristics of the present invention will be apparent from the description of the present specification and the accompanying drawings.

The following is a brief description of an outline of the typical embodiment of the invention disclosed in the present application.

A network system according to this embodiment includes: a plurality of fabric switches; and a plurality of port switches connected to the plurality of fabric switches through a plurality of links. The port switch sets a link aggregation group to the plurality of links connected to the plurality of fabric switches, and when the port switch receives a multicast management frame, it transfers the frame to each of the plurality of fabric switches. The fabric switch has a table in which information of a port which has received a frame and a source MAC address of a received frame are registered, and when the fabric switch receives the multicast management frame, it registers information of a port which has received the frame and a source MAC address of the frame in the table.

Also, a network relay device of this embodiment is connected to a plurality of other network relay devices through a plurality of links, sets a link aggregation group to the plurality of links connected to the plurality of other network relay devices, and when receiving a multicast management frame, transfers the frame to the plurality of other network relay devices.

According to one embodiment, it is possible to provide a network system and a network relay device capable of suppressing the occurrence of the flooding.

### BRIEF DESCRIPTIONS OF THE DRAWINGS

FIG. 1 is a block diagram showing an overall configuration of a network system according to an embodiment;

FIG. 2 is a block diagram showing a configuration of a network system according to an embodiment;

FIG. 3A is a diagram for describing a link aggregation group and a link port according to an embodiment;

FIG. 3B is a diagram for describing a link aggregation group and a link port according to an embodiment;

FIG. 4A is a diagram showing a configuration of a port switch according to an embodiment;

FIG. 4B is a diagram showing a format of an IGMP frame according to an embodiment;

FIG. 5 is a flowchart showing an operation of a port switch according to an embodiment;

FIG. 6A is a diagram showing a configuration of a fabric switch;

FIG. 6B is a diagram showing registered contents of a forwarding database (hereinafter, referred to as FDB) table; and

FIG. 7 is a schematic diagram for describing an operation of a network system of an embodiment.

### DESCRIPTIONS OF THE PREFERRED EMBODIMENTS

Hereinafter, embodiments of the present invention will be described in detail with reference to the accompanying drawings. Note that components having the same function are denoted by the same reference characters throughout the drawings for describing the embodiments, and the repetitive description thereof will be omitted.

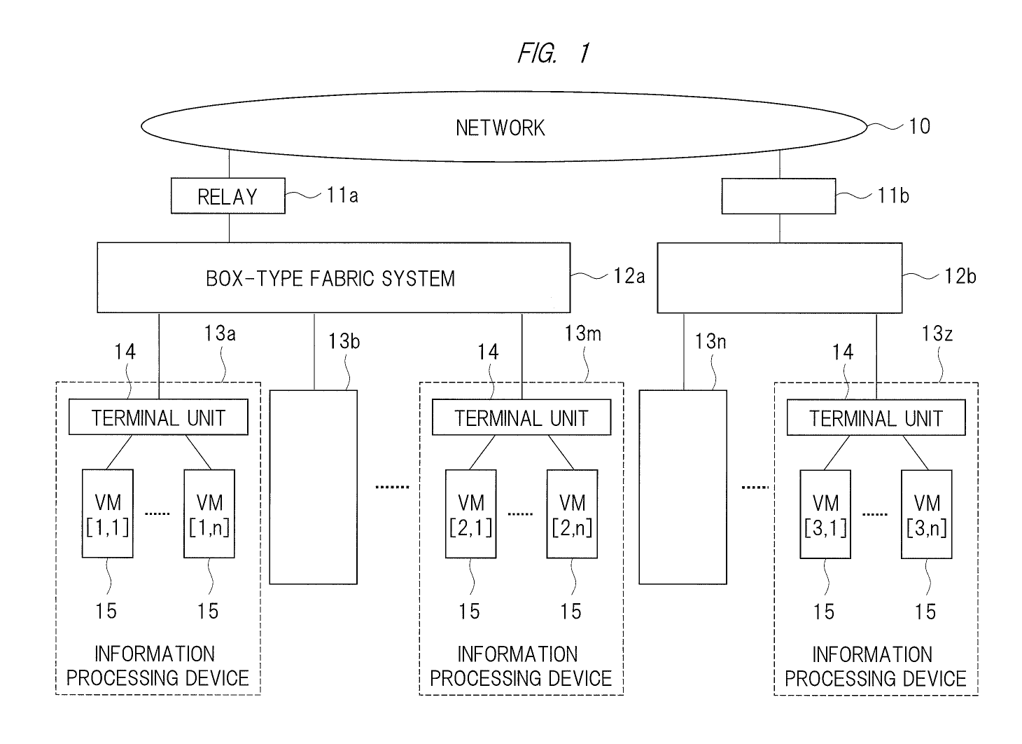

FIG. 1 is a block diagram showing an overall configuration of a network system according to an embodiment. FIG. 1 shows a network system using VXLAN. In FIG. 1, a reference character 10 denotes a network, reference characters 11a and 11b denote relays, reference characters 12a and 12b denote box-type fabric systems, and reference characters 13a to 13z denote information processing devices. The network 10 is connected to the box-type fabric system 12a through the relay 11a, and the information processing devices 13a to 13m are connected to the box-type fabric system 12a. Also, the network 10 is connected to the box-type fabric system 12b through the relay 11b, and the information processing devices 13n to 13z are connected to the box-type fabric system 12b. The relays 11a and 11b have the same configuration, the box-type fabric systems 12a and 12b have the same configuration, and the information processing devices 13a to 13z have the same configuration. Hereinafter, the relay 11a, the box-type fabric system 12a and the information processing devices 13a to 13m connected to the network 10 will be described in detail.

In FIG. 1, as examples of the information processing devices 13a to 13m, the configurations of the information processing devices 13a and 13m are shown in detail. The configuration of the information processing device will be described by taking the information processing device 13a as an example. The information processing device 13a includes a plurality of virtual machines 15 and a terminal unit 14 connected between the virtual machines 15 and the box-type fabric system 12a. For distinguishing the individual virtual machines 15, in FIG. 1, the virtual machines 15 are identified as VM[1,1] to VM[1,n]. The virtual machines 15 may be separate computers or computers virtually realized in one or plural computers.

The terminal unit 14 has an IP (Internet Protocol) address and a MAC address by which the terminal unit 14 itself is specified, and virtual MAC addresses for specifying the virtual machines VM[1,1] to VM[2,n] are given to the respective virtual machines VM[1,1] to VM[2,n].

In the following description, the case where a frame is transmitted from the virtual machine VM[1,1] in the information processing device 13a to the virtual machine VM [2,1] in the information processing device 13m is taken as an example. A frame (MAC frame) whose destination is a virtual MAC address of VM[2,1] and whose source is a virtual MAC address of VM [1,1] is transmitted from the virtual machine VM[1,1] to the terminal unit 14. The terminal unit 14 in the information processing device 13a adds a header compliant with the standard of VXLAN to the frame to encapsulate it. Concretely, the terminal unit 14 in the information processing device 13a adds a header having the IP address and the MAC address of the terminal unit 14 in the information processing device 13a as information of the source and having the IP address and the MAC address of the terminal unit 14 in the information processing device 13m as information of the destination to the frame to form an encapsulated frame, and transmits it to the box-type fabric system 12a.

The box-type fabric system 12a transmits the encapsulated frame to the information processing device 13m based on the MAC address of the terminal unit 14 in the information processing device 13m to be a destination contained in the received encapsulated frame.

The terminal unit 14 of the information processing device 13m deletes the header compliant with the standard of VXLAN from the received encapsulated frame. Then, the terminal unit 14 of the information processing device 13m transmits the frame to the virtual machine VM [2,1] based on the virtual MAC address of the virtual machine VM[2,1] contained as the destination MAC address in the frame.

Thereafter, for example, when the frame is transmitted from the virtual machine VM[2,1] to the virtual machine VM[1,1], the process reverse to that described above is performed. In this case, the frame is previously transmitted from the virtual machine VM[1,1] to the virtual machine VM[2,1] through the box-type fabric system 12a. Therefore, the box-type fabric system 12a has learned the MAC address of the terminal unit 14 in the information processing device 13a. Therefore, the occurrence of flooding can be suppressed and the information processing device 13a can be specified from the received encapsulated frame.

The frame transmission between specific information processing devices 13a and 13m has been described. In other cases, for example, a frame is transmitted from the virtual machine VM[1,1] of the information processing device 13a to virtual machines in a plurality of information processing devices 13b to 13m belonging to the same VXLAN segment. In this case, the virtual machine VM [1,1] in the information processing device 13a transmits the frame by broadcast or multicast. The broadcast or multicast frame transmitted by the virtual machine VM[1,1] is transferred by IP multicast between the terminal units 14 of the information processing devices 13a to 13m. As a join and leave protocol to and from a multicast group for each VXLAN, IGMP is used.

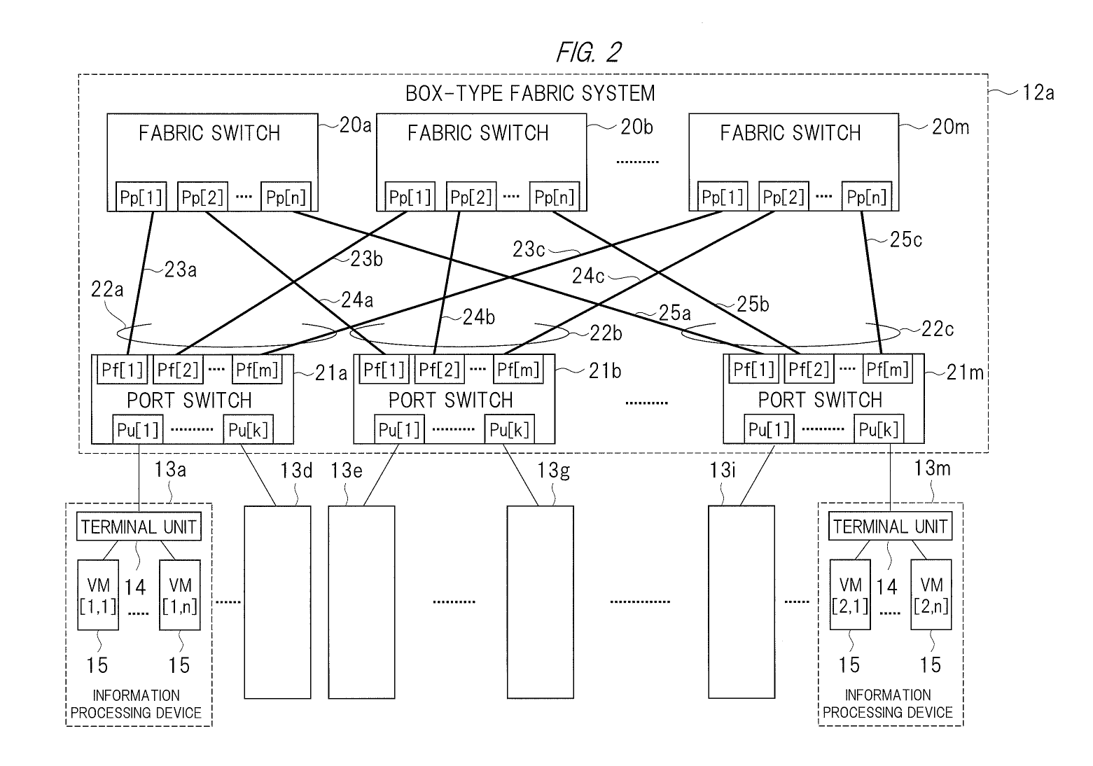

FIG. 2 is a block diagram showing a configuration of the box-type fabric system shown in FIG. 1. In this specification, the box-type fabric system shown in FIG. 2 corresponds to the network system. Note that FIG. 2 shows the configuration of the box-type fabric system 12a as a representative example. FIG. 2 also shows the information processing devices 13a to 13m in order to indicate the relation between the box-type fabric system 12a and the information processing devices 13a to 13m.

As a system which relays the transmission and reception of a frame, a so-called chassis-type switching device has been known. In the embodiment described in this specification, a system which relays a frame by combining a plurality of box-type switching devices is used instead of the chassis-type switching device. The relay system configured by combining a plurality of box-type switching devices is referred to as a box-type fabric system in this specification.

The box-type fabric system 12a shown as a representative example includes a plurality of box-type switching devices (hereinafter, referred to as port switch) 21a, 21b, . . . , and 21m and a plurality of box-type switching devices (hereinafter, referred to as fabric switch) 20a, 20b, . . . , and 20m functioning to relay a frame between the port switches 21a, 21b, . . . , and 21m.

The port switch 21a has a plurality of ports, and some of the ports are set as user ports Pu[1], . . . , and Pu[k] which are connected to the information processing devices 13a, . . . , and 13d serving as users and perform transmission and reception of a frame to and from the corresponding information processing devices. Also, other ports of the plurality of ports are set as link ports Pf[1], Pf[2], . . . , and Pf[m] connected to the plurality of fabric switches 20a, 20b, . . . , and 20m through the plurality of links 23a, 23b and 23c. In this embodiment, the link aggregation group (hereinafter, referred to as LAG) 22a is set to the plurality of links 23a, 23b and 23c mentioned above.

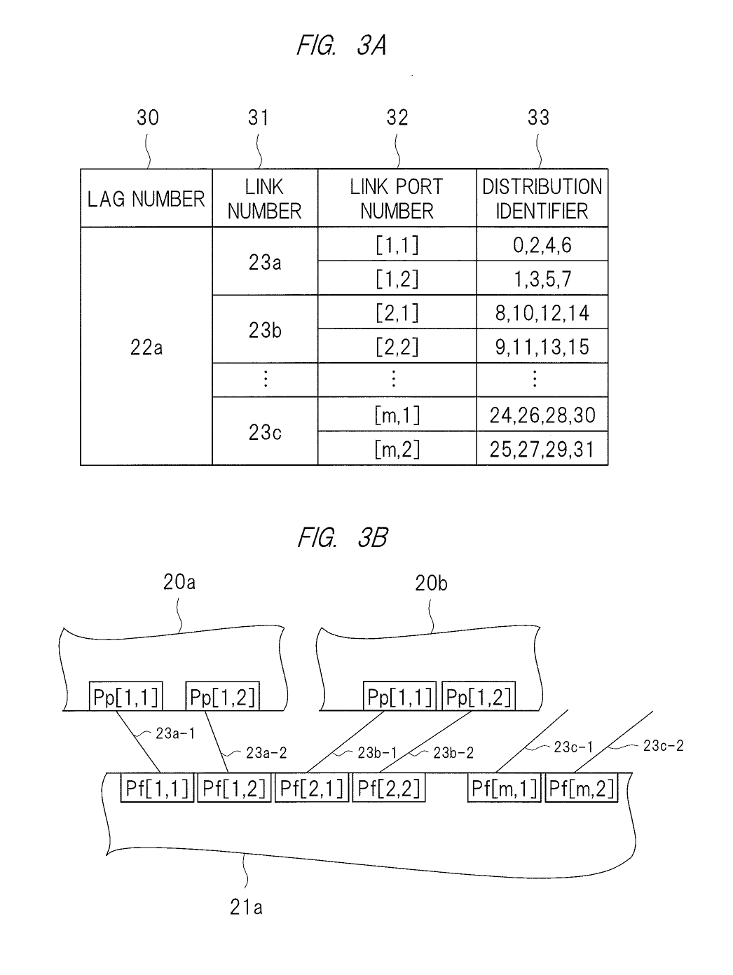

When the port switch 21a relays a frame received at specific user ports Pu[1], . . . and Pu[k] to another port switch, the port switch 21a relays the received frame so as to be properly distributed within the plurality of links 23a, 23b and 23c set as the LAG. Though described later with reference to FIG. 3, the distribution in the LAG is performed based on a predetermined rule.

Each of the port switches 21b to 21m has the same configuration as that of the port switch 21a. More specifically, each of the port switches 21b to 21m also has a plurality of ports, some of the plurality of ports are set as a plurality of user ports Pu[1] to Pu[k], and the information processing devices 13e to 13m are connected to the respective user ports Pu[1] to Pu[k]. Also, link ports Pf[1] to Pf[m] connected to the fabric switches 20a to 20m through the plurality of links 24a to 24c and 25a to 25c are set to the respective port switches 21b to 21m. LAG 22b is set to the plurality of links 24a to 24c, and LAG 22c is set to the plurality of links 25a to 25c.

In this manner, like the port switch 21a, the frame received at the user ports of the port switches 21b to 21m is relayed so as to be properly distributed within the links 24a to 24c and the links 25a to 25c in the LAG 22b and the LAG 22c. Since the frame is relayed so as to be properly distributed within the LAG, the port switch and the fabric switch are physically connected in a one-to-multiple manner, and the frame is logically transferred in a one-to-one manner.

The fabric switch 20a has link ports Pp[1], Pp[2] . . . , and Pp[n] connected to the link ports Pf[1] of the port switches 21a, 21b, . . . , and 21m through the links 23a, 24a, . . . , and 25a. The fabric switch 20a relays the frame received at a specific link port to another specific link port. For example, it relays the frame received at the link port Pp[1] through the link 23a to the link port Pp[2].

In this manner, the frame received at the link port Pp[1] of the fabric switch through the link 23a is relayed to the link port Pf[1] of the port switch 21b. At this time, for example, the port switch 21b transfers the frame received at the link port Pf[1] to the user port Pu[1]. Consequently, the frame transmitted from the information processing device 13a is relayed to the information processing device 13e. Since the fabric switches 20b to 20m have the same configuration as that of the fabric switch 20a, the description thereof will be omitted.

At the time of relaying the frame, the source of the frame is specified by the source IP address and MAC address contained in the frame. Also, the destination of the frame is specified by the destination IP address and MAC address contained in the frame. In this embodiment, the IP address and the MAC address are the IP address and the MAC address of the terminal unit 14 provided in each of the information processing devices 13a to 13m as described above.

FIG. 3A shows a table indicating the relation among a LAG number, a link number, a link port number and a distribution identifier. The table shown in FIG. 3A is a table relating to the port switch 21a, and similar tables are provided in each of the port switches 21b to 21m.

In FIG. 3A, a LAG number 22a of the port switch 21a shown in FIG. 2 is registered in a LAG number column 30. Link numbers 23a, 23b and 23c shown in FIG. 2 are registered in a link number column 31. There are a plurality of fabric switches, and there are also a plurality of links. It should be understood that only the links 23a, 23b and 23c are shown as representative examples of the plurality of links in FIG. 3A. Also, numbers of link ports in the port switch 21a are registered in a link port number column 32. In a distribution identifier column 33, though described later, distribution identifiers used when relaying a frame so as to be distributed within the LAG are registered.

FIG. 3B is a schematic diagram for describing the connection between the port switch 21a and the fabric switches 20a and 20b described above. Each of the links 23a to 23c, 24a to 24c and 25a to 25c is physically composed of a plurality of wires in case of the breaking or the like. In FIG. 2, in order to avoid complicating the drawing, each of the link ports Pf[1] to Pf[m] and Pp[1] to Pp[n] is presented as one port. However, each of the link ports Pf[1] to Pf[m] and Pp[1] to Pp[n] is composed of a plurality of link ports. FIG. 3B shows the case in which each of the link ports Pf[1] to Pf[m] and Pp[1] to Pp[n] is composed of two link ports. Of course, each of the link ports may be composed of three or more link ports.

More specifically, as shown in FIG. 3B, the link port Pf[1] (see FIG. 2) is composed of two link ports Pf[1,1] and Pf[1,2] and the link port Pp[1] (see FIG. 2) is composed of two link ports Pp[1,1] and Pp[1,2], and they are connected by physical wires 23a-1 and 23a-2.

Similarly, the link port Pf[2] (see FIG. 2) is composed of two link ports Pf[2,1] and Pf[2,2] and the link port Pf[1] (see FIG. 2) of the fabric switch 20b is composed of two link ports Pp[1,1] and Pp[1,2], and they are connected by physical wires 23b-1 and 23b-2. The fabric switch 20m is also connected to two link ports Pf[m,1] and Pf[m,2] by physical wires 23c-1 and 23c-2 in the same manner. In FIG. 2, links are indicated by heavy lines in order to clearly specify that the links are composed of a plurality of wires.

The description returns to FIG. 3A. The reason why two link port numbers are assigned to the same link number is that one link is physically composed of two link ports and two wires in this embodiment as described with reference to FIG. 3B. For example, two link ports Pf[1,1] and Pf[1,2] are assigned to one link 23a (see FIG. 2). Subsequently, two link ports Pf [2,1] and Pf [2,2] are similarly assigned to one link 23b (see FIG. 2) and two link ports Pf[m,1] and Pf[m,2] are assigned to one link 23c (see FIG. 2).

Next, one example of the distribution rule in the LAG will be described. In this embodiment, a distribution identifier for the distribution is obtained by calculation based on the information of source and the information of destination of the frame. As the information of source, the source IP address contained in the transmitted frame is used, and as the information of destination, the destination IP address contained in the frame is used. The exclusive OR between the source IP address and the destination IP address is calculated by binary number representation, decimal representation of the calculated value obtained by the calculation is divided by a predetermined value (for example, 32), and a remainder value of the division serves as the distribution identifier for the distribution.

Hence, the remainder value falls within the range from 0 to 31 depending on the source IP address and the destination IP address. The remainder values 0 to 31 are assigned to the link port numbers. In the example shown in FIG. 3A, remainder values 0, 2, 4 and 6 are assigned to the link port number [1,1], and remainder values 1, 3, 5 and 7 are assigned to the link port number [1,2]. Similarly, remainder values 8, 10, 12 and 14 are assigned to the link port number [2,1] , and remainder values 9, 11, 13 and 15 are assigned to the link port number [2,2]. Furthermore, remainder values 24, 26, 28 and 30 are assigned to the link port number [m,1], and remainder values 25, 27, 29 and 31 are assigned to the link port number [m,2].

When the port switch 21a receives a frame at the user ports Pu[1] to Pu[k] and transmits it to the fabric switch, it performs the above-described operation by using the source IP address and the destination IP address contained in the frame, thereby obtaining the remainder value corresponding to the distribution identifier. Then, it obtains the link port number corresponding to the obtained remainder value from the table shown in FIG. 3A, and transfers the frame to the fabric switch through the link port corresponding to the obtained link port number. In this manner, the frame is transferred to one of the fabric switches in the plurality of fabric switches physically connected in a one-to-multiple manner. In other words, the link port in accordance with the distribution identifier is selected from the link ports Pf[1] to Pf[m] included in one LAG, and the frame is transferred from the selected link port.

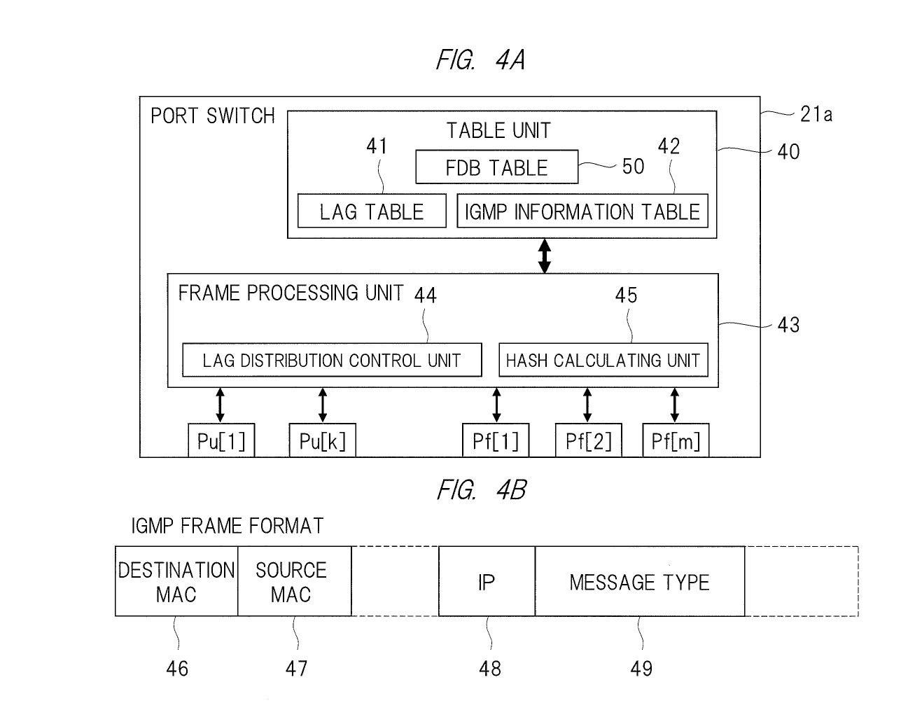

FIG. 4A is a block diagram showing the configuration of the port switch. In FIG. 4A, the configuration of the port switch 21a is shown as a representative example.

In FIG. 4A, a reference character 43 denotes a frame processing unit, and it includes a LAG distribution control unit 44 and a hash calculating unit 45. Also, a reference character 40 denotes a table unit which stores various kinds of information, and a LAG table 41, an IGMP information table 42 and a FDB table 50 are provided in this embodiment. In FIG. 4, Pu[1] and Pu[k] indicate the user ports shown in FIG. 2, and Pf[1], Pf[2] and Pf[m] indicate the link ports shown in FIG. 2. The frame processing unit 43 is connected to the user ports Pu[1] and Pu[k] and the link ports Pf[1], Pf[2] and Pf[m], and when it receives a frame at the user port Pu[1] or Pu[k], it relays the frame to any one of the link ports Pf[1], Pf[2] and Pf[m]. Also, when the frame processing unit 43 receives a frame at any one of the link ports Pf[1], Pf[2] and Pf[m], it relays the received frame to the user port Pu[1] or Pu[k].

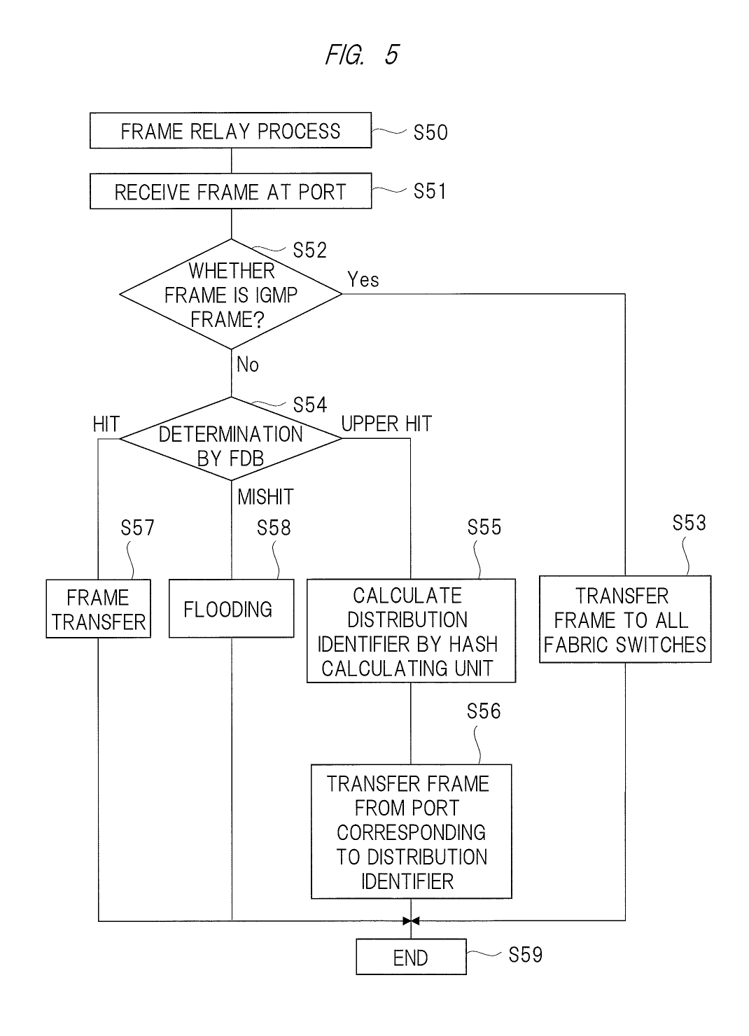

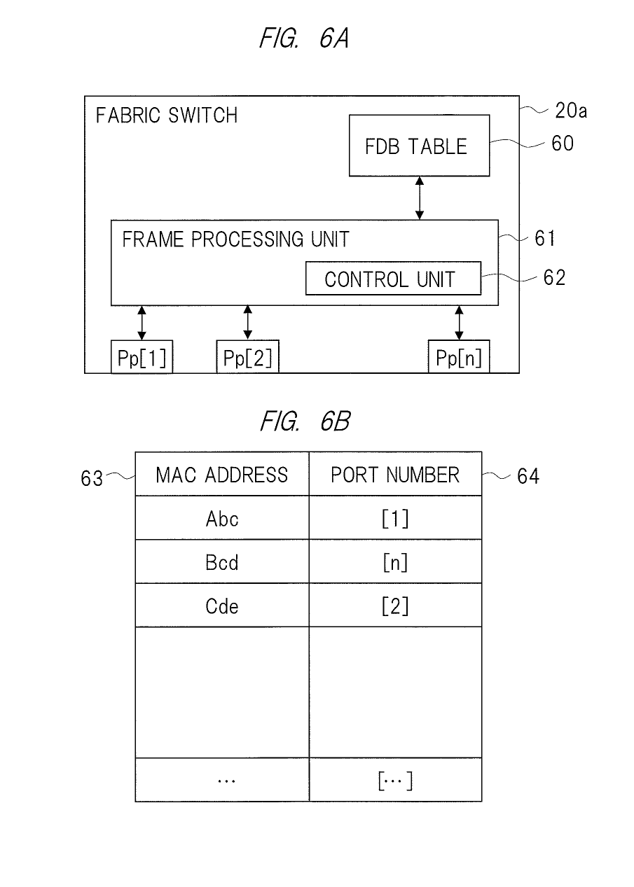

At the time of relaying the frame as described above, the frame processing unit 43 performs the process with reference to the information stored in the table unit 40. In the LAG table 41 provided in the table unit 40, the table shown in FIG. 3A is formed. More specifically, the table having the distribution identifiers and the link port numbers corresponding thereto is formed in the LAG table 41. Also, in the FDB table 50, though an example thereof will be described later with reference to FIG. 6B, a plurality of MAC addresses, port numbers of the user ports corresponding to respective MAC addresses and port numbers of link ports or LAG numbers (not shown in FIG. 6B) are registered. When the destination MAC address contained in the received frame has been registered in the FDB table 50, though described later with reference to FIG. 5, the received frame is transferred to the port in accordance with the port number corresponding to the registered MAC address or the link port in the LAG number.

When a frame is received at the user port Pu[1] or Pu[k] and transferred to the fabric switch, the hash calculating unit 45 included in the frame processing unit 43 performs the operation described with reference to FIG. 3A by using the source IP address and the destination IP address contained in the frame. The remainder value calculated by this operation, that is, the distribution identifier is transferred to the LAG distribution control unit 44. The LAG distribution control unit 44 transfers the frame received at the user port to the link port in accordance with the distribution identifier with reference to the link port number stored in the LAG table 41 and the table of the distribution identifier corresponding thereto. In this manner, the relay in accordance with the distribution within the LAG is performed.

In this embodiment, the IGMP information table 42 is provided in the table unit 40. A message type contained in the IGMP frame is stored in the IGMP information table 42. As the message type stored therein, there are a host membership report, a host membership query and a leave group as described above.

FIG. 4B shows an example of a format of an IGMP frame. In FIG. 4B, a reference character 47 denotes a region in which a MAC address of a source from which the frame is transmitted is stored, and a reference character 46 denotes a region in which a MAC address of a destination showing the destination of the frame is stored. The IGMP is encapsulated by an IP header 48 and is then sent. In FIG. 4B, a reference character 49 denotes a region in which a message type of the IGMP is stored. Though not shown in FIG. 4B, the IP header 48 includes a region in which a source IP address is stored and a region in which a destination IP address is stored.

FIG. 5 is a flowchart showing an operation of a port switch. Next, an operation of the port switch 21a will be described with reference to FIG. 5.

First, in the box-type fabric system 12a, the frame relay process is started in the step S50. A frame transmitted from any one of the information processing devices 13a to 13e is received at any one of the user ports Pu[1] to Pu[k].

The port switch 21a recognizes which of the user ports Pu[1] to Pu [k] receives the frame in the step S51. When the frame is received at any one of the user ports Pu[1] to Pu[k], it is determined whether or not the received frame is an IGMP frame in the step S52. The message type contained in the IGMP frame is preliminarily stored in the IGMP information table 42 provided in the port switch 21a. The frame processing unit 43 compares the message type stored in the IGMP information table 42 and the message type stored in the region 49 of the received frame in the step S52.

When the received frame does not contain the message type stored in the IGMP information table 42, it is determined that the frame is not an IGMP frame, and the step S54 is next executed. Meanwhile, when the received frame contains the message type stored in the IGMP information table 42, it is determined that the frame is an IGMP frame, and the step S53 is next executed.

In the step S54, it is determined whether or not the destination MAC address contained in the received frame has been registered in the FDB table 50 (determination by FDB). When it matches the MAC address registered in the FDB table 50, that is, it hits and the matched MAC address corresponds to the LAG number, the step S55 is next executed as an upper hit. Meanwhile, when it hits and the matched MAC address corresponds to the port number other than the LAG number, the step S57 is next executed.

In the step S57, the received frame is transferred to the link port having the port number obtained from the FDB table 50. Thereafter, the step S59 is executed.

Meanwhile, when the upper hit is determined in the step S54, the source IP address and the destination IP address contained in the received frame are transferred to the hash calculating unit 45, and the operation described with reference to FIG. 3A is performed in the step S55. The remainder value obtained by the operation serves as the distribution identifier. The distribution identifier calculated in the step S55 is transferred to the step S56. In the step S56, the LAG distribution control unit 44 retrieves the link port number corresponding to the distribution identifier from the LAG table 41 based on the calculated distribution identifier. The LAG distribution control unit 44 transfers the received frame to the link port corresponding to the link port number obtained by the retrieval. As a result, the received frame is transferred from the link port corresponding to the distribution identifier. After the transfer of the frame, the frame relay process ends in the step S59.

If the MAC address contained in the received frame does not match the MAC address registered in the FDB table in the step S54, that is, it mishits, the flooding is performed (step S58). In the step S58, the received frame is transferred to all of the ports other than the port which has received the frame. At this time, the step S55 and the step S56 are executed to the port to which the LAG number is set and the port corresponding to the distribution identifier is selected, so that the received frame is transferred to the selected port.

In this manner, the received frame hits when the destination MAC address contained therein has been registered in the FDB table 50, and it is transferred to the link port having the port number registered in the FDB table 50 or the link port in the LAG number. On the other hand, the received frame mishits when the destination MAC address contained therein is not registered in the FDB table 50, and the flooding is performed (step S58).

Meanwhile, when the received frame is the IGMP frame, the frame processing unit 43 transfers the received frame to all of the link ports Pf[1], Pf[2], . . . , and Pf[m] in the step S53. More specifically, in this case, the received frame is transferred to all of the fabric switches connected to the port switch 21a. At this time, for example, the LAG distribution control unit 44 stops its operation. In the step S53, after the received frame is transferred to all of the fabric switches, the frame relay process ends in the step S59.

In the transfer of the IGMP frame to all of the fabric switches, when one link corresponds to a plurality of physical link ports as shown in FIG. 3A and FIG. 3B, the frame is transferred by using one link port in the plurality of link ports. In this case, for example, the frame is transferred to the fabric switch from the link port having a smaller link port number in the plurality of link port numbers. For example, in FIG. 3A, in the link 23a, the IGMP frame is transferred from the link port Pf[1,1] corresponding to the smaller link port number [1,1] in the two link ports. Similarly, in the link 23b and the link 23c, the frame is transferred from the link port Pf[2,1] and the link port Pf[m,1].

As described above, when the received frame is an IGMP frame, the received IGMP frame is transferred from the port switch which has received the frame to all of the fabric switches connected thereto. Consequently, the source MAC address and the destination MAC address contained in the received frame are transferred to all of the fabric switches.

Next, the configuration of the fabric switch will be described with reference to FIG. 6. The fabric switch has a FDB table in which, when a frame is received, a number of the link port which has received the frame and a source MAC address contained in the frame are stored as a pair. When the received frame is an IGMP frame, the frame is transferred to all of the fabric switches. Therefore, the source MAC address in the received frame and the number of the port which has received the frame are registered in the FDB tables of the fabric switches. In other words, when the received frame is an IGMP frame, the FDB tables of all of the fabric switches are synchronized so as to store the same source MAC address and port number of the port which has received the frame.

Next, the configuration of the fabric switch will be described with reference to FIG. 6A and FIG. 6B. FIG. 6A is a block diagram showing a configuration of a fabric switch. FIG. 6A shows a configuration of the fabric switch 20a as a representative example.

In FIG. 6A, a reference character 61 denotes a frame processing unit, and it includes a control unit 62. Also, a reference character 60 denotes an FDB table, and FIG. 6B shows a configuration example thereof. Note that, in FIG. 6A, Pp[1], Pp[2], . . . , and Pp[n] denote link ports of the fabric switch 20a shown in FIG. 2.

The frame processing unit 61 is connected to the link ports Pp[1], Pp[2], . . . , and Pp[n] and the FDB table 60, and when a frame is received at any one of the link ports Pp[1], Pp[2], . . . , and Pp[n], the frame processing unit 61 relays the frame to the link ports other than the link port which has received the frame based on the control of the control unit 62. At this time, the frame processing unit 61 transfers the source MAC address and the number of the link port which has received the frame contained in the received frame to the FDB table 60. The transferred source MAC address and the number of the link port which has received the frame containing it are registered as a pair in the FDB table 60.

For example, when the source MAC address of the received frame is Abc and the link port which has received the frame is the link port Pp[1], as shown in FIG. 6B, the source MAC address “Abc” is registered in a MAC address column 63 of the FDB table 60 and the port number [1] of the link port Pp[1] is registered in a corresponding port number column 64. Subsequently, the source MAC address in the received frame and the port number of the link port which has received the frame are similarly registered as a pair in the FDB table 60. Note that, since the memory capacity of the memory which constitutes the FDB table is finite, when the frame is received and the source MAC address and the port number are registered, for example, the pair of the source MAC address and the port number registered previously is cleared.

For example, the information of the pair of the MAC address and the port number stored in the FDB table 60 is used when relaying a new frame. More specifically, when a new frame is received, if the source MAC address corresponding to a destination MAC address contained in the frame is registered in the FDB table 60, the number of the link port to which the received new frame is to be transferred can be obtained by retrieving the FDB table 60. In this manner, the frame can be efficiently relayed. In other words, the MAC address and the port number corresponding thereto are learned by receiving the frame. When a frame is received, if the MAC address corresponding to the destination MAC address contained in the frame is not registered in the FDB table 60, the flooding is likely to be performed.

As described above, in this embodiment, when a port switch receives an IGMP frame, the port switch relays the IGMP frame to all of the fabric switches connected to the port switch, and the source MAC address of the IGMP frame and the number of the port which has received the frame are registered in the FDB table 60 in all of the fabric switches. Consequently, the occurrence of the flooding caused due to that the MAC address is not registered in the FDB table 60 can be suppressed, and the efficient network relay device and network system can be provided.

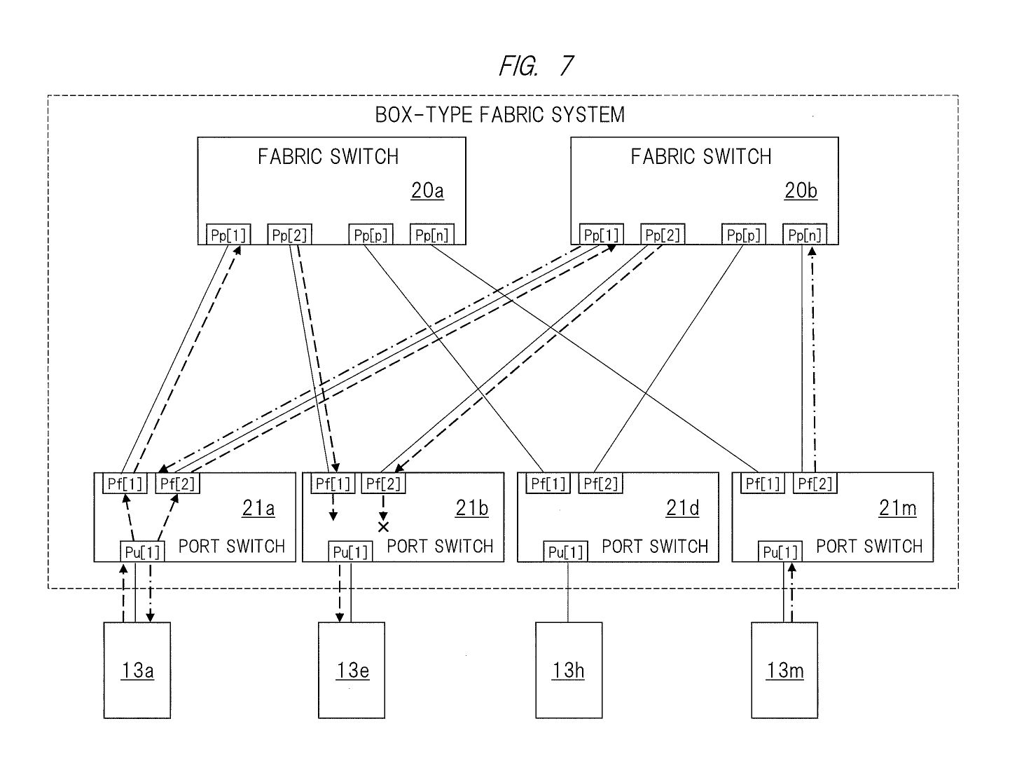

Next, the operation relating to this embodiment will be described with reference to FIG. 7. FIG. 7 is a schematic diagram for describing an operation of the box-type fabric system shown in FIG. 2. In FIG. 7, the parts common to those in FIG. 2 are denoted by the same reference characters, and only the parts relating to the description of the operation are shown.

In FIG. 7, reference characters 20a and 20b denote fabric switches corresponding to the fabric switches 20a and 20b shown in FIG. 2. Reference characters 21a, 21b and 21m denote port switches corresponding to the port switches 21a, 21b and 21m in FIG. 2. Reference characters 13a, 13e and 13m denote information processing devices corresponding to the information processing devices 13a, 13e and 13m in FIG. 2. In FIG. 7, reference characters 13h and 21d denote an information processing device and a port switch though they are not shown in FIG. 2.

In FIG. 7, dashed lines indicate frame relay paths in the case where an IGMP frame is transmitted from the information processing device 13a to the user port Pu[1] of the port switch 21a. Also, one-dot dashed lines indicate relay paths in the case where a frame is relayed from the information processing device 13m to the information processing device 13a after the IGMP frame is transmitted from the information processing device 13a.

First, when the port switch 21a (first port switch) receives an IGMP frame at the user port Pu[1], it transfers the frame to all of the fabric switches as described above. In FIG. 7, the frame is transferred from the link ports Pf[1] and Pf[2] (second port) of the port switch 21a to the link ports Pp[1] (first port) of the fabric switches 20a and 20b (fabric switch). By this transfer, the fabric switches 20a and 20b register the source MAC address contained in the frame and the number of the link port which has received the frame as a pair in the FDB table 60 provided in each of the fabric switches 20a and 20b. In this case, the source MAC address is the MAC address of the terminal unit 14 of the information processing device 13a and the number of the link port is the link port Pp[1].

The fabric switch 20a transfers the IGMP frame from the link port Pp[2] (fourth port) to the link port Pf[1] (third port) of the port switch 21b (second port switch). At this time, the fabric switch 20b also transfers the received frame from the link port Pp[2] (fourth port) to the link port Pf[2] (third port) of the port switch 21b. The port switch 21b (second port switch) receives the frame at each of the link ports Pf[1] and Pf[2] (third port). In this case, the port switch 21b processes the IGMP frame received at the link port having a smaller number (specific port) as a valid frame, and transfers it to the information processing device 13e. On the other hand, for example, the IGMP frame received at the other link port is discarded (× mark).

Concretely, this can be achieved by determining whether or not the frame received at the link ports Pf[1] and Pf[2] is the IGMP frame by using the message type of IGMP stored in the IGMP information table 42 provided in the port switch 21b, and then validating the frame received at a specific link port in accordance with the result of the determination. More specifically, when the received frame is the IGMP frame, the link port Pf[1] having a smaller number is set as a specific link port, and the frame received at that link port is validated and the frame received at the other link port Pf[2] is discarded.

As described above, in the case where the MAC address of the information processing device 13a is registered in each of the fabric switches 20a and 20b, when the frame is transmitted from the information processing device 13m to the information processing device 13a, the fabric switch 20b can relay the frame as shown by the one-dot dashed lines by using the registered MAC address of the information processing device 13a. More specifically, the fabric switch 20b can detect the matching between the destination MAC address of the newly relayed frame and the MAC address of the information processing device 13a registered in the FDB table 60 and transmit the new frame from the link port Pp[1] corresponding to the MAC address of the information processing device 13a.

In FIG. 7, reference characters Pf and Pp which are not used in the foregoing description are shown, and these denote the link ports of the fabric switch and the port switch.

As a network protocol, there exists UDP (User Datagram Protocol). In the frame transfer using UDP, the frame transfer in one direction is performed in some cases. For example, in FIG. 7, the frame transfer from the information processing device 13e to the information processing devices 13a and 13h is performed. When the frame transfer using the UDP continues for a relatively long time, there is a possibility that the MAC addresses of the information processing devices 13a and 13h and the link port corresponding thereto are cleared from the FDB tables 60 of the fabric switches 20a and 20b. Therefore, for example, it is also possible to appropriately send an IGMP frame from the information processing device 13a, thereby updating the MAC address of the information processing devices 13a and the link port corresponding thereto in each of the fabric switches 20a and 20b.

In FIG. 3A and FIG. 3B, an example in which one link is composed of a plurality of link ports has been shown, but the link is not limited to this. For example, one link may be composed of one link port. In this case, in FIG. 3A, one link port number is assigned to the respective link numbers 23a, 23b and 23c, and the distribution identifier is assigned to the respective link port numbers.

Also, the method of calculating the distribution identifier is not limited to that described in this embodiment. For example, it is also possible to obtain the distribution identifier by the operation using either the information of source or the information of destination.

In this embodiment, the case where the IGMP frame is used as the multicast management frame has been described, but the multicast management frame is not limited to the IGMP frame. As the multicast management frame, for example, there is a frame of a protocol such as MLD. In this case, the MLD frame is determined as a multicast management frame in a port switch, and the MLD frame is transferred to all of the fabric switches connected to the port switch.

The fabric switches 20a to 20m and the port switches 21a to 21m shown in FIG. 2 are composed of the network relay devices with the same configuration. The network relay devices with the same configuration function as fabric switches and port switches depending on settings. For example, when the port switch 21a shown in FIG. 2 is considered as a network relay device, the user ports Pu[1] to Pu[k] of the port switch 21a are considered as first ports which receive a frame transmitted from an information processing device, and each of the link ports Pf[1] to Pf[m] is considered as a second port. It can be considered that the plurality of network relay devices (20a to 20m) are connected to the link ports Pf[1] to Pf[m] , and it can be considered that the link aggregation group is set to the links to the plurality of network relay devices.

In the foregoing, the invention made by the inventor of the present invention has been concretely described based on the embodiment. However, the present invention is not limited to the foregoing embodiment and various modifications and alterations can be made within the scope of the present invention.

What is claimed is:

1. A network system, comprising:
a plurality of fabric switches; and
a plurality of port switches connected to the plurality of fabric switches through a plurality of links,
wherein the port switch sets a link aggregation group to the plurality of links connected to the plurality of fabric switches,
when the port switch receives a multicast management frame, it transfers the frame to each of the plurality of fabric switches,
the fabric switch has a table in which information of a port which has received a frame and a source MAC address of a received frame are registered, and
when the fabric switch receives the multicast management frame, it registers information of a port which has received the frame and a source MAC address of the frame in the table.

2. The network system according to claim 1,
wherein, when the port switch receives the multicast management frame from the plurality of fabric switches, it validates only the frame received at a specific port in the plurality of ports connected to the plurality of fabric switches.

3. The network system according to claim 1,
wherein a protocol of the multicast management frame is IGMP (Internet Group Management Protocol) or MLD (Multicast Listener Discovery).

4. A network relay device, which is connected to a plurality of other network relay devices through a plurality of links, sets a link aggregation group to the plurality of links connected to the plurality of other network relay devices, and when receiving a multicast management frame, transfers the frame to the plurality of other network relay devices.

5. The network relay device according to claim 4, which when receiving the multicast management frame from the plurality of other network relay devices, validates only the frame received at a specific port in the plurality of ports connected to the plurality of other network relay devices.

6. The network relay device according to claim 4,
wherein a protocol of the multicast management frame is IGMP (Internet Group Management Protocol) or MLD (Multicast Listener Discovery).
